(19) United States
(12) Patent Application Publication
(10) Pub. No.: US 2024/0416655 A1
(43) Pub. Date: Dec. 19, 2024

(54) METHOD OF INKJET PRINTING

(71) Applicant: RAYLEIGH VISION LIMITED, Kowloon (HK)

(72) Inventors: Jr-Hau HE, Hsinchu City (TW); Chun-Wei TSAI, New Taipei City (TW); Zhi-Ting YE, Miaoli County (TW); Yuk-Tong CHENG, Kowloon (HK)

(21) Appl. No.: 18/210,189

(22) Filed: Jun. 15, 2023

(51) Int. Cl. B41J 2/145; C09D 11/03; C09D 11/54

(52) U.S. Cl. CPC B41J 2/145; C09D 11/03; C09D 11/54

(57) ABSTRACT

The present invention provides a method of inkjet printing, which comprises the following steps: using a first inkjet printhead member of an inkjet device to print the first ink on a carrier and forming a first drop; after a first time, a second inkjet printhead member of the inkjet device printing the second ink on the carrier and forming a second drop, the first drop and the second drop overlapping and forming a mixing region; the second drop in the mixing region supersaturating the first drop and precipitating a nucleus in the mixing region; and the second drop continuing to mix with the first drop and extending the mixing region, and the nucleus continuing to precipitate in the mixing region and forming a crystal.

### BACKGROUND OF THE INVENTION

Because perovskite is an excellent optoelectronic material, it is extensively applied to solar cells. In general, in the process of forming a perovskite film on a substrate, a perovskite precursor coated on the substrate will be heated to evaporate the solvent in the perovskite precursor and form a perovskite film by perovskite precursor reaction.

According to the prior art, a perovskite precursor is placed on a substrate. After evaporation, perovskite crystals will form. Unfortunately, this method will generate numerous tiny crystals; it is difficult to form a single crystal. While mass producing a large area of perovskite, this problem will become apparent.

Presently, the methods for manufacturing perovskite include the following: (1) Coating method; (2) Injection coating method; (3) Continuous inkjet (CIJ) method; and (4) Drop demand inkjet (DOD) method.

Among them, the coating method and the injection coating method are suitable for large-area mass production because the perovskite precursor is coated on the substrate directly. The perovskite manufactured by using these two methods will derive many tiny crystal ores and hence making the quality of the formed perovskite inferior.

On the other hand, the continuous inkjet method injects ink drops continuously from the printhead. Then these drops are used as the printing drops and guided to the substrate. Alternatively, they are guided to a collector for recycling and reuse. The advantages of inkjet printing include large-area printing, requiring no metal mask or photomask, high material utility, adaptive to panels with varied sizes, manufacturable in the atmosphere ambiance, requiring no expensive vacuum equipment, low material and equipment costs. Thereby, inkjet printing is distinct from the process for light-emitting devices according to the prior art.

Unfortunately, the manufacturing method of perovskite as described above requires pre-process for the substrate. For example, the substrate should be annealed or the surface roughness should be increased. Alternatively, a complicated temperature control is required to evaporate the liquid in the perovskite precursor and crystalize.

This method of evaporation and crystallization will induce the coffee-ring effect during the crystallization process of perovskite and disabling the perovskite crystal from forming the desired matrix direction or pattern. Consequently, the applications of perovskite will be affected.

The above coffee-ring effect refers to situation when a drop of coffee or tea drops on the table, the particles therein will remain on the table and form a dyed stain. The color of the stain is not uniform. The edge will appear darker than the middle, forming a ring pattern. The main causes include the shape of the particles and the flowing direction.

In addition, the causes of the coffee-ring effect also include different inkjet parameters in crystallization. Then ring-shaped stains with light colors at the center and dark colors at the outer rings will be formed on the surface of the substrate. As a result, the quality of the formed perovskite can not be improved.

Accordingly, how to improve the method of inkjet printing so that single-crystal perovskite pattern can be given after printing has become the main challenge for the technical staffs in this field.

### SUMMARY OF THE INVENTION

An objective of the present invention is to provide a method of inkjet printing, which uses a first inkjet printhead to print the perovskite precursor on a carrier. Then an anti-solvent is used to alter the perovskite precursor and form a crystal on the carrier.

To achieve the above objective, the present invention provides a method of inkjet printing, which comprises the following steps: using a first inkjet printhead member of an inkjet device to print the first ink on a carrier and forming a first drop; after a first time, a second inkjet printhead member of the inkjet device printing the second ink on the carrier and forming a second drop, the first drop and the second drop overlapping and forming a mixing region, the first drop having a first drop diameter, the second drop having a second drop diameter, and the first drop diameter greater than the second drop diameter; the second drop in the mixing region supersaturating the first drop and precipitating a nucleus in the mixing region; and the second drop continuing to mix with the first drop and extending the mixing region, and the nucleus continuing to precipitate in the mixing region and forming a crystal.

According to an embodiment of the present invention, in the step of after a first time, a second inkjet printhead member of the inkjet device printing the second ink on the carrier and forming a second drop and the first drop and the second drop overlapping and forming a mixing region, the mixing region is located between a first center of the first drop and a second center of the second drop.

According to an embodiment of the present invention, in the step of the second drop in the mixing region supersaturating the first drop and precipitating a nucleus in the mixing region, the drop ratio of the first drop to the second drop ranges from 1:1 to 3:1.

According to an embodiment of the present invention, in the step of using a first inkjet printhead member of an inkjet device to print the first ink on a carrier and forming a first drop, the carrier is a semiconductor material.

According to an embodiment of the present invention, in the step of using a first inkjet printhead member of an inkjet device to print the first ink on a carrier and forming a first drop, the first inkjet printhead member includes a first ink container and a first inkjet printhead communicating with the first ink container.

According to an embodiment of the present invention, in the step of using a first inkjet printhead member of an inkjet device to print the first ink on a carrier and forming a first drop, the first ink include a perovskite precursor and a solvent, and the solvent is dimethylformamide.

According to an embodiment of the present invention, in the step of after a first time, a second inkjet printhead member of the inkjet device printing the second ink on the carrier and forming a second drop and the first drop and the second drop overlapping and forming a mixing region, the first time is between 0.5 second and 1.5 seconds.

According to an embodiment of the present invention, in the step of after a first time, a second inkjet printhead member of the inkjet device printing the second ink on the carrier and forming a second drop and the first drop and the second drop overlapping and forming a mixing region, the second inkjet printhead member includes a second ink container and a second printhead communicating with the second ink container.

According to an embodiment of the present invention, in the step of after a first time, a second inkjet printhead member of the inkjet device printing the second ink on the carrier and forming a second drop and the first drop and the second drop overlapping and forming a mixing region, the second ink is an anti-solvent and the anti-solvent is ethylene glycol, isopropanol, toluene, or n-hexane.

According to an embodiment of the present invention, the size of the crystal is controlled within the mixing region and the crystal is located on the carrier.

### BRIEF DESCRIPTION OF DRAWINGS

FIG. 1 shows a flowchart of the method of inkjet printing according to an embodiment of the present invention;

FIG. 2A shows a schematic diagram of the operation of the method of inkjet printing according to an embodiment of the present invention;

FIG. 2B shows a schematic diagram of the operation of the method of inkjet printing according to an embodiment of the present invention;

FIG. 2C shows a schematic diagram of the operation of the method of inkjet printing according to an embodiment of the present invention; and

FIG. 2D shows a schematic diagram of the operation of the method of inkjet printing according to an embodiment of the present invention.

### DETAILED DESCRIPTION OF THE INVENTION

According to the method of forming perovskite by evaporation, the coffee-ring effect will occur during the crystallization process of perovskite. The causes of the coffee-ring effect include different inkjet parameters in crystallization. Then ring-shaped stains with light colors at the center and dark colors at the outer rings will be formed on the surface of the substrate. As a result, the quality of the formed perovskite can not be improved, disabling the perovskite crystal from forming the desired matrix direction or pattern and thus limiting the applications.

The present invention improves the method of inkjet printing, which uses a first inkjet printhead to print the perovskite precursor on a carrier. Then an anti-solvent is used to alter the perovskite precursor and form a crystal on the carrier.

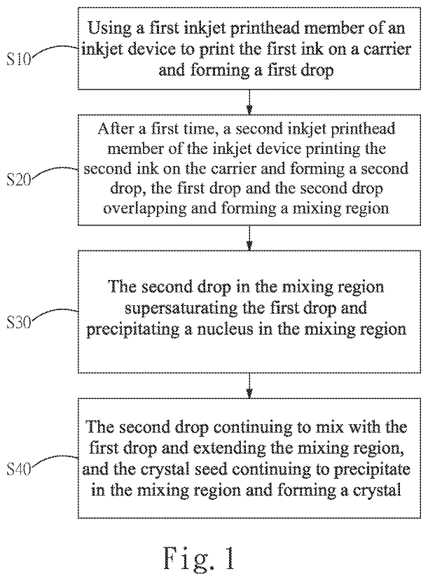

First, please refer to FIG. 1, which shows a flowchart of the method of inkjet printing according to an embodiment of the present invention. The method of inkjet printing according to an embodiment comprises the following steps:

Step S10: Using a first inkjet printhead member of an inkjet device to print the first ink on a carrier and forming a first drop;

Step S20: After a first time, a second inkjet printhead member of the inkjet device printing the second ink on the carrier and forming a second drop, the first drop and the second drop overlapping and forming a mixing region;

Step S30: The second drop in the mixing region supersaturating the first drop and precipitating a nucleus in the mixing region; and

Step S40: The second drop continuing to mix with the first drop and extending the mixing region, and the nucleus continuing to precipitate in the mixing region and forming a crystal.

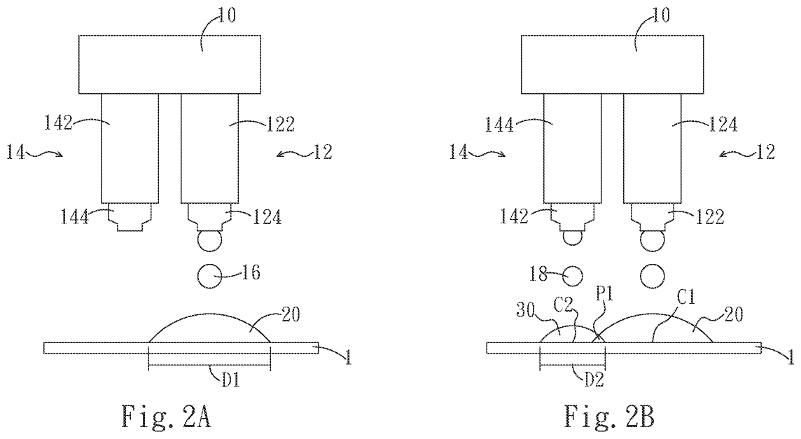

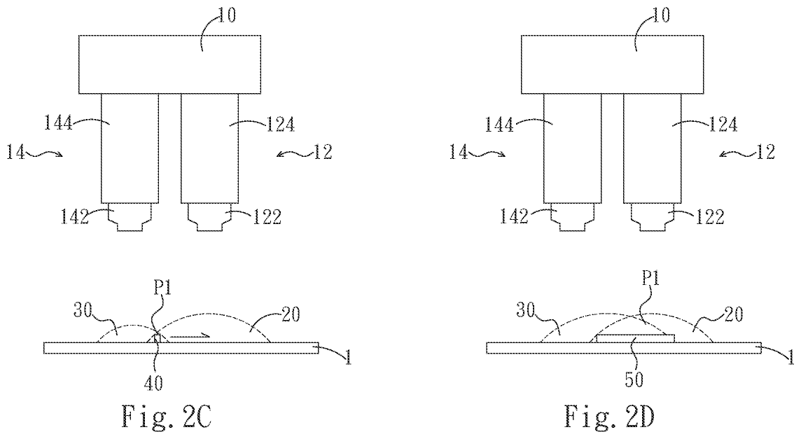

According to the present embodiment, please refer to the step S10 and FIGS. 2A to 2D, which show schematic diagrams of the operation of the method of inkjet printing according to an embodiment of the present invention. As shown in the figures, according to the present embodiment, a first inkjet printhead member 12 of an inkjet device 10 prints the first ink 16 on a carrier. The first ink 16 forms a first drop 20 on the carrier 1. The first drop 20 has a first drop diameter D1. The carrier is a semiconductor material.

Please refer again to FIG. 2A again. According to the present embodiment, the first inkjet printhead member 12 includes a first ink container 122 and a first inkjet printhead 124. The first inkjet printhead 124 communicates with the first ink container 122. The first ink container 122 is used for storing the first ink 16.

According to the present embodiment, the first ink 16 includes a perovskite precursor and a solvent. The solvent is dimethylformamide (DMF). The first ink 16 is formed by dissolving PbBr2 (1M) and H3NH3Br (1M) in dimethylformamide.

Next, please refer again to FIG. 2B. In the step S20 of the present embodiment, after a first time, a second inkjet printhead member 14 of the inkjet device 10 prints the second ink 18 on the carrier 1 and forming a second drop 30. The first drop 20 and the second drop 30 overlap to form a mixing region P1. The first time is between 0.5 second and 1.5 seconds. The second drop 30 according to the present embodiment has a second drop diameter D2.

According to the present embodiment, the second inkjet printhead member 14 includes a second ink container 142 and a second inkjet printhead 144. The second inkjet printhead 144 communicates with the second ink container 142. The second ink container 142 is used for storing the second ink 18.

According to the present embodiment, the second ink 18 is an anti-solvent. The anti-solvent is ethylene glycol, isopropanol, toluene, or n-hexane used for supersaturating the first drop 20.

Please refer again to FIG. 2C. In the step S30 of the present embodiment, the second drop 30 in the mixing region P1 supersaturates the first drop 20 in the mixing region P1 and precipitates a nucleus 40 in the mixing region P1.

According to the present embodiment, the mixing region P1 is located between a first center C1 of the first drop 20 and a second center C2 of the second drop 30.

Finally, please refer again to FIG. 2D. According to the present embodiment, as shown in the step S40, the second drop 30 continues to mix with the first drop 20 (as the dashed lines in FIG. 2D) and extend the mixing region P1. In addition, the nucleus 40 continues to precipitate in the mixing region P1 to form a crystal 50. The mixing region P1 is an initial crystallization spot of the crystal 50. In other words, the location of the precipitated nucleus 40 in the mixing region P1 is the initial crystallization spot of the crystal 50. The size of the crystal 50 is controlled within the mixing region P1 and the crystal 50 is controlled at the location of the carrier 1.

According to the present embodiment, the first drop diameter D1 is greater than the second drop diameter D2. By controlling the size of the first drop 20, the size of the crystal 50 can be controlled.

Furthermore, according to the present embodiment, the drop ratio of the first drop 20 to the second drop 30 ranges from 1:1 to 3:1. By controlling the drop ratio of the first drop 20 to the second drop 30, the volume of the crystal 50 can be controlled.

Besides, according to the present embodiment, a growth temperature of the crystal 50 is the room temperature, which is different the high-temperature ambiance according to the prior art (the drop evaporation method). Thereby, the energy can be saved and the growth of the crystal 50 is rapid.

The drop evaporation method according to the prior art will lead to the coffee-ring effect in the crystallization process. The causes of the coffee-ring effect include different inkjet parameters in crystallization. Then ring-shaped stains with light colors at the center and dark colors at the outer rings will be formed on the surface of the substrate. As a result, the quality of the formed perovskite can not be improved, disabling the perovskite crystal from forming the desired matrix direction or pattern and thus limiting the applications.

The advantage of the present embodiment is that the edges of the first drop 20 and the second drop 30 contact so that the concentration on the edge of the first drop 20 is raised and supersaturated by the second drop 30 and further precipitating the nucleus 40. Thereby, the growth location of the nucleus 40 can be controlled effectively. By using the properties of the first drop 20 and the second drop 30, the nucleus 40 can grow to the crystal 50 rapidly. The present embodiment can prevent the crystal 50 from the coffee-ring effect and can pattern the crystal 50 directly.

The embodiment of the present invention will be illustrated in the following.

To produce the crystal 50, the first inkjet member 12 and the second inkjet member 14 print on the carrier 1. Nonetheless, they cannot print on the same location. Once printing on the same location, many tiny crystals 50 will be formed in the overlap region.

Thereby, the nucleation and growth of perovskite (the crystal 50) should be controlled. The proper distance between the first drop 20 and the second drop 30, which turn into the precursor (the first ink 16) and the anti-solvent (the second ink 18), respectively, plays a critical role.

According to the present embodiment, the form of the grown perovskite (the crystal 50) strongly depends on the overlap location of the anti-solvent (the second ink 18) and the precursor (the first ink 16). To grow a single perovskite (the crystal 50), only a nucleus 40 can formed in the mixing region P1; multiple nuclei 40 should be avoided.

Accordingly, to acquire a single perovskite (the crystal 50), use the drop ratio 3:1 to print the precursor (the first ink 16) and the anti-solvent (the second ink 18) on the carrier 1. According to the present example, the first drop diameter D1 of the first drop 20 of the precursor (the first ink 16) is greater than the second drop diameter D2 of the second drop 18 of the anti-solvent (the second ink 18).

When the second drop 30 of the anti-solvent (the second ink 18) is printed to the edge of the first drop 20 of the precursor (the first ink 16), the mixing region P1 will be formed. The second drop 30 of the anti-solvent (the second ink 18) will supersaturate the first drop 21 in the mixing region P1 and thus precipitating the nucleus 40.

Next, the second drop 30 of the anti-solvent (the second ink 18) continues to mix with the first drop 20 of the precursor (the first ink 16) and extend the mixing region P1. The nucleus 40 will continue to be precipitated in the mixing region P1 and forming a single perovskite (the crystal 50).

By using the edge deposition strategy according to the present embodiment, the nucleation and growth of the precursor (the first ink 16) with various size can be controlled with ease and forming a single large-diameter perovskite (the crystal 50) on various substrates (the carrier 1, including various hydrophilicity and crystal orientation).

As described in the above embodiment, the present invention provides a method of inkjet printing. The first inkjet printhead of the inkjet device prints the perovskite precursor to the carrier. Next, the anti-solvent is used to alter the perovskite precursor and form a crystal on the carrier. Then the coffee-ring effect can be avoided and the crystal can be patterned directly.

1. A method of inkjet printing, comprising steps of:
using a first inkjet printhead member of an inkjet device to print the first ink on a carrier and forming a first drop;
after a first time, a second inkjet printhead member of said inkjet device printing the second ink on said carrier and forming a second drop, said first drop and said second drop overlapping and forming a mixing region, said first drop having a first drop diameter, said second drop having a second drop diameter, and said first drop diameter greater than said second drop diameter;
said second drop in said mixing region supersaturating said first drop and precipitating a nucleus in said mixing region; and
said second drop continuing to mix with said first drop and extending said mixing region, and said nucleus continuing to precipitate in said mixing region and forming a crystal.

2. The method of inkjet printing of claim 1, wherein said step of after a first time, a second inkjet printhead member of said inkjet device printing the second ink on said carrier and forming a second drop and said first drop and said second drop overlapping and forming a mixing region, said mixing region is located between a first center of said first drop and a second center of said second drop.

3. The method of inkjet printing of claim 1, wherein said step of said second drop in said mixing region supersaturating said first drop and precipitating a nucleus in said mixing region, the drop ratio of said first drop to said second drop ranges from 1:1 to 3:1.

4. The method of inkjet printing of claim 1, where in said step of using a first inkjet printhead member of an inkjet device to print said first ink on a carrier and forming a first drop, said carrier is a semiconductor material.

5. The method of inkjet printing of claim 1, wherein said step of using a first inkjet printhead member of an inkjet device to print the first ink on a carrier and forming a first drop, said first inkjet printhead member includes a first ink container and a first inkjet printhead communicating with said first ink container.

6. The method of inkjet printing of claim 1, wherein said step of using a first inkjet printhead member of an inkjet device to print the first ink on a carrier and forming a first drop, said first ink include a perovskite precursor and a solvent, and said solvent is dimethylformamide.

7. The method of inkjet printing of claim 1, wherein said step of after a first time, a second inkjet printhead member of said inkjet device printing the second ink on said carrier and forming a second drop and said first drop and said second drop overlapping and forming a mixing region, said first time is between 0.5 second and 1.5 seconds.

8. The method of inkjet printing of claim 1, wherein said step of after a first time, a second inkjet printhead member of said inkjet device printing the second ink on said carrier and forming a second drop and said first drop and said second drop overlapping and forming a mixing region, said second inkjet printhead member includes a second ink container and a second printhead communicating with said second ink container.

9. The method of inkjet printing of claim 1, wherein said step of after a first time, a second inkjet printhead member of said inkjet device printing the second ink on said carrier and forming a second drop and said first drop and said second drop overlapping and forming a mixing region, said second ink is an anti-solvent and said anti-solvent is ethylene glycol, isopropanol, toluene, or n-hexane.

10. The method of inkjet printing of claim 1, wherein the size of said crystal is controlled within said mixing region and said crystal is located on said carrier.
